(19) United States
(12) Patent Application Publication
(10) Pub. No.: US 2009/0184087 A1
(43) Pub. Date: Jul. 23, 2009

(54) Personal Identifier for Beverage Container

(76) Inventors: Peter DeSanto, Peterborough (CA); Anna Tremblay, Oakville (CA); Jeffrey Beleutz, Oakville (CA)

Correspondence Address: KILYK & BOWERSOX, P.L.L.C., 400 HOLIDAY COURT, SUITE 102, WARRENTON, VA, 20186, US

(21) Appl. No.: 12/338,055

(22) Filed: Dec. 18, 2008

(30) Foreign Application Priority Data
Dec. 19, 2007 (CA) 2615545

(51) Int. Cl. B65D 25/00; B42D 15/00

(52) U.S. Cl. 215/386; 283/74

(57) ABSTRACT

A personal identifier device for a beverage container is provided. The device has a display member having a top surface with a personal identification indicia such as a logo printed thereon. An elongate fastening member having a tip is used to pierce the cap of a bottle to attach the device to the bottle cap such that the indicia is visible from above. The tip is blunted for safety reasons. The tip and elongated member provide a means to allow the device to effectively pierce and seal so as to prevent unwanted leakage of the container's liquid contents while the device is attached. The tip and elongated member provide a means to allow for the quick and easy evacuation of the container's liquid contents, upon manual squeezing of the container, once the device has been temporarily and replaceably removed. The device ensures that the user can identify his or her own beverage container in a reliable, effective and safe manner.

### FIELD OF THE INVENTION

The present invention is related to personal identification devices for beverage containers such as bottled water.

### BACKGROUND OF THE INVENTION

Drinks sold in single serving sized containers have been very popular with the public for many generations. These beverages are also sources of large sales volumes for beverage manufacturers. In recent years, bottled water sold in single 500 ml serving size plastic bottles have become so popular that these bottles are virtually ubiquitous at public parks, playgrounds and other public events.

The ubiquity of bottled water containers poses a number of challenges. Firstly, it has proven to be easy to lose track of one's bottle once having set it down, given the number of other bottles in the immediate vicinity. There is a risk that a user could inadvertently pick up and drink from a bottle that was set down by someone else. Such accidental sharing of water bottles could lead to an increased rate of the transmission of disease.

As a result of the risk of picking up the wrong water bottle, consumers often abandon their partly drunk bottles once having set down the bottle amidst other similar bottles. This is typically done in order to avoid risking drinking from someone else's contaminated bottle. However, the abandonment of partially consumed water bottles causes environmental concerns. Firstly, there is the problem of wastage of water and secondly, the abandonment of water bottles causes both pollution and an increased consumption level of plastic materials. Both of these outcomes have deleterious environmental effects.

There is, therefore, a need for a method and device for identifying one's beverage bottle or container in a way that differentiates the container from those of others.

One attempted solution to this problem is disclosed in U.S. Pat. No. 6,745,505. This reference discloses the concept of providing packages of beverage bottles that have color-coded beverage caps. The different coloured caps help to differentiate the bottles thereby making it easier for a consumer to identify their bottle. However, the popularity of such a scheme makes it likely that enough different users can buy the same type of packages and end up with bottles having the same coloured cap and confusion will still result.

U.S. Pat. No. 6,086,702 discloses a method of identifying a bottle with personal indicia in the form of letters that are affixed onto a bottle with adhesive stickers. Although this method serves to distinguish bottles in a personal way, it is cumbersome.

There is therefore a need for a device that distinguishes beverage containers in an effective manner and that is safe and easy to use.

The present invention provides a device that has surface that displays a personal identifier in the form of a preferred logo, name, slogan or the like. The device has an attaching portion that pierces a plastic cap or bottle. The piercing mechanism is configured with a safety tip so that injury is avoided if the mechanism is withdrawn from the bottle.

According to one aspect of the invention, there is provided a personal identifier for a beverage container comprising: a display member having a first surface with identification means affixed thereto and a second surface; and an elongate fastening member connected to the second surface, the fastening member having a remote end for piercing the beverage container, the remote end having a blunted safety tip.

### BRIEF DESCRIPTION OF THE DRAWINGS

The present invention will be described in greater detail with reference to the accompanying drawings, in which like numerals refer to like parts and in which different embodiments of the same parts are indicated by the same reference numeral with a prime.

FIG. 1 is a top perspective view of a preferred embodiment of the present invention;

FIG. 2 is a bottom perspective view of the preferred embodiment of the present invention;

FIG. 3 is a bottom view of the preferred embodiment of the present invention;

FIG. 4 is a bottom view of an attachment member of the preferred embodiment of the present invention; and

FIG. 5 is a side view of the preferred embodiment of the present invention;

In the drawings, preferred embodiments of the invention are illustrated by way of example. Other further advantages and features of the invention will be apparent to those skilled in the art from the following detailed description thereof and the accompanying drawings.

It is expressly understood that the description and drawings are illustrative of certain embodiments of the invention, but the invention itself is defined by the accompanying claims.

### DETAILED DESCRIPTION OF THE PREFERRED EMBODIMENTS

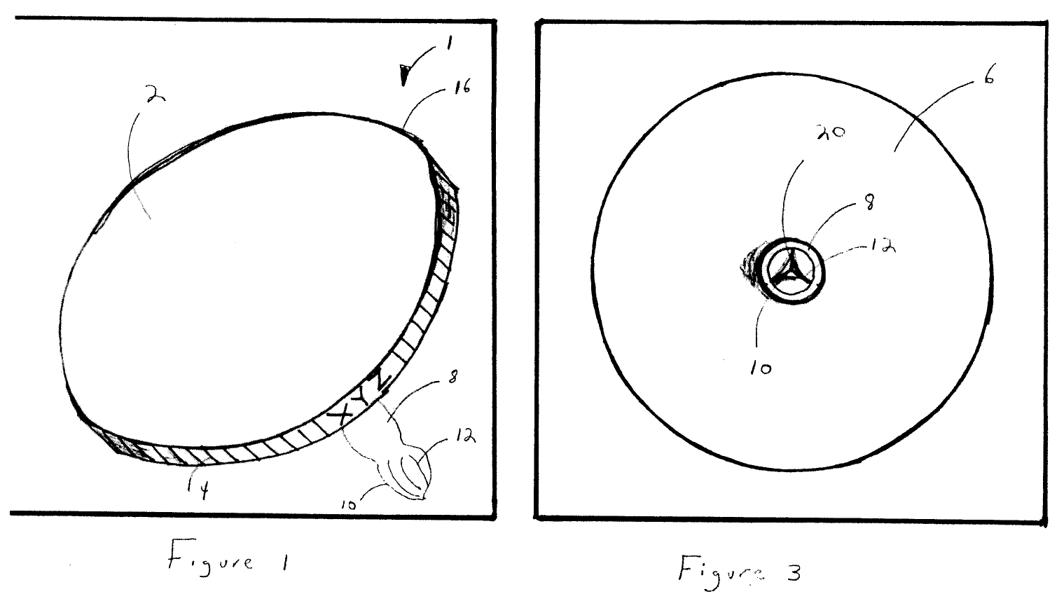

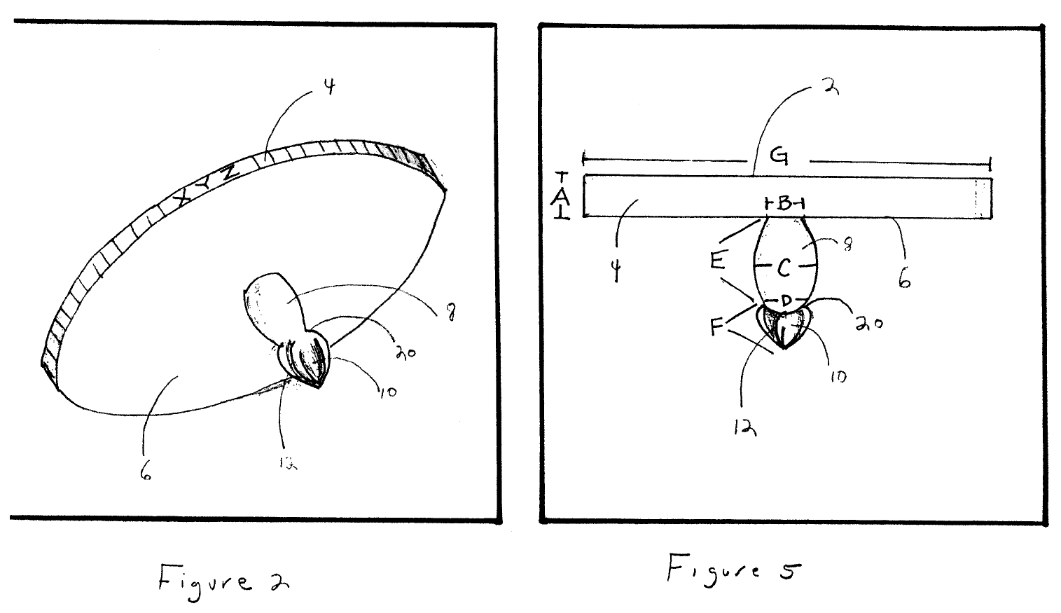

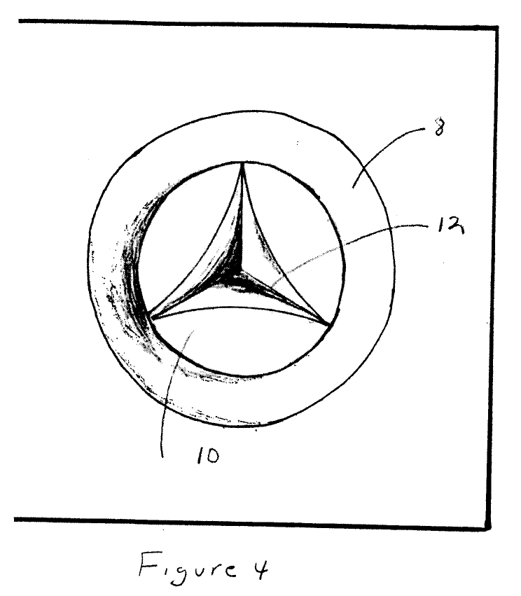

As shown in FIG. 1, personal identifier device 1 has a display member 16 that is connected to a longitudinal fastening member 8.

The display member 16 is preferably planar having a first surface 2, a side surface 4 and a bottom surface 6. The display member 16 is preferably in the shape of a disc. The first surface 2 preferably has indicia printed thereon. However, it is possible to attach other identifiers such as three-dimensional identifiers thereto according to methods known in the art. The display member 16 may assume various other shapes in alternate embodiments.

The longitudinal fastening member 8 is attached to the bottom surface 6 and extends downwardly therefrom. The longitudinal fastening member 8 is preferably a shaft or a rod. In alternate embodiments, the longitudinal fastening member 8 may include horizontal ribs that encircle the diameter of the longitudinal fastening member 8 to provide extra friction in order to lessen chances of leakage and/or unintended removal of the device 1. The longitudinal fastening member 8 is preferably shaped with a central diameter wider than a diameter of ends of the member 8 to provide greater friction and sealing while inhibiting unintended removal of the device 1.

The longitudinal fastening member 8 has a tip 10 for piercing a thin wall of plastic or a material of similar strength. The tip 10 is preferably rounded or otherwise blunted and is preferably formed of a material such as plastic such that it does not pose a significant safety risk. The tip 10 is preferably also tapered and preferably includes longitudinal ribs or knife edges 12 for tearing the material forming a cap or container after the tip pierces the material forming a cap or container. In alternate embodiments, the tip 10 can have a jagged profile such as an arrow shaped profile a spade shaped profile. The tip preferably includes an engagement surface 20 for impeding accidental removal of the device 1.

The device 1 is preferably constructed of a plastic material such as polyethylene vinyl chloride. A person skilled in the art will readily appreciate that other materials can also be used provided that the attachment member 8 has sufficient strength to pierce a thin plastic wall.

In operation, a personal identifier such as a personal logo or name is printed on the first surface 2 of the display member 16. It is also possible to attach an advertisement or the logo of a favourite sports team to the first surface 2. The personal identifier present on the first surface 2 is visible and serves as a differentiation marker. Any differentiation marker is within the scope of the present invention.

The tip 10 is preferably pierced into a plastic cap of a bottled water bottle. Since the fastening member 8 extends downwardly from the display member 16, the first surface 2 is visible from above when the device 1 is inserted in the bottle cap. The tip can alternatively be inserted into the bottle itself or into metal cans or the caps or corks of glass bottles.

The tip 10 is preferably blunted or rounded so that a user will not be accidentally cut or otherwise injured if the device 1 becomes dislodged. The tip 10 is configured such that the longitudinal ribs or knife edges 12 tear into a plastic cap. Once inserted, the engagement surface 20 of the tip 10 impedes accidental removal of the device 1 from the bottle cap. The optional tapering aspect of the tip 10 and the inclusion of longitudinal ribs 1 provide additional functional and safety benefits.

The plastic cap of a bottled water bottle should not leak after insertion of the tip 10 and fastening member 8. The optional inclusion of horizontal encircling ribs on the longitudinal fastening member 8 serve to prevent said leakage and accidental removal of invention. In fact, a bottled water bottle can be used as a squeezable spray bottle for quick and easy evacuation of the bottle's liquid contents, after insertion and then temporary and replaceable removal of the device 1, thereby providing an additional practical benefit.

Although various preferred embodiments of the present invention have been described herein in detail, it will be appreciated by those skilled in the art that variations may be made thereto without departing from the spirit of the invention or the scope of the appended claims.

The embodiments of the invention in which an exclusive property or privilege is claimed are defined as follows:

1. A personal identifier for a beverage container comprising: a display member having a first surface with identification means affixed thereto and a second surface; and an elongate fastening member connected to the second surface, the fastening member having a remote end for piercing the beverage container, the remote end having a blunted safety tip.

2. A personal identifier according to claim 1 wherein the blunted safety tip is rounded.

3. A personal identifier according to claim 1 wherein the blunted safety tip is tapered.

4. A personal identifier according to claim 3 wherein the blunted safety tip comprises a plurality of longitudinal ribs or knife edges.

5. A personal identifier according to claim 1 wherein the blunted safety tip has a spade shaped profile.

6. A personal identifier according to claim 1 wherein the blunted safety tip has an arrow shaped profile.

7. A personal identifier according to claim 1 wherein the display member is a disc wherein the display surface is a top surface of the display member, the second surface being a bottom surface of the display member.

8. A personal identifier according to claim 7 wherein the attachment member is a rod or shaft extending from the second surface of the display member.

9. A personal identifier according to claim 1 wherein the identification means is indicia printed on said display surface.

10. A personal identifier according to claim 1 wherein the personal identifier is made of plastic.

11. A personal identifier according to claim 1 wherein the beverage container is a plastic bottle.

12. A personal identifier according to claim 11 wherein the beverage is water.
